(19) United States
(12) Patent Application Publication
(10) Pub. No.: US 2005/0083831 A1
(43) Pub. Date: Apr. 21, 2005

(54) Optical disc medium

(76) Inventors: Keiji Nishikiori, Yawata-shi (JP); Yoshihiro Kawasaki, Hirakata-shi (JP); Eiji Ohno, Hirakata-shi (JP); Kazuhiro Hayashi, Kadoma-shi (JP)

Correspondence Address: Wenderoth Lind & Ponack, 2033 K Street NW, Suite 800, Washington, DC, 20006, US

(21) Appl. No.: 10/503,981

(22) PCT Filed: Dec. 17, 2002
(86) PCT No.: PCT/JP02/13162

(30) Foreign Application Priority Data
Apr. 8, 2002 (JP) 2002-104827

(51) Int. Cl. G11B 7/24

(52) U.S. Cl. 369/275.4; 369/275.3

(57) ABSTRACT

A high-definition and high-precision optical disc medium suitable for high density includes a recording layer which has an inner peripheral region extending radially outwardly from a central bore to a signal start boundary and a signal region extending radially outwardly from the signal start boundary. A light transmitting layer is disposed on the recording layer and the signal region of one face of the recording layer adjacent to the light transmitting layer occupies a laser beam incident face such that either reproduction or recording and reproduction of information is performed from the recording layer via the light transmitting layer. The inner peripheral region of the face of the recording layer is formed flat and a recess is formed, on one face of the optical disc medium opposite to the light transmitting layer, in an area corresponding to the inner peripheral region of the recording layer.

### TECHNICAL FIELD

The present invention relates to a high-density optical disc medium.

### BACKGROUND ART

In recent years, optical discs are widely applied to audio and visual (AV) fields. For example, in a digital versatile disc (DVD) mainly for movie contents, formats of write once read many (WORM) type and rewritable type such as a DVD-R, a DVD-RAM and a DVD-RW have been developed and the DVDs come into popular use as a next-generation recording device of a video tape recorder (VTR). In response to future diffusion of BS digital broadcasting and broadband communication, it is expected that an optical disc format which enables recording of compressed images of higher quality or an optical disc format which makes a portable optical disc more compact at an identical capacity and has high network affinity will appear.

These next-generation optical discs should have high density absolutely. In DVDs proposed currently, a disc of 120 mm in diameter has a capacity of 4.7 GB. However, a capacity of 20 GB or more is required for a ROM having a picture quality identical with that of digital broadcasting or for performing recording and reproduction. At this time, a density of five times or more is necessary.

Usually, density of an optical disc depends on a spot diameter of a light beam for recording and reproduction and the spot diameter of the light beam is determined by (λ/NA) in which “λ” denotes a wavelength and “NA” denotes a numerical aperture of an objective lens. Therefore, in order to raise the density, it is necessary to reduce the wavelength and increase the numerical aperture. If the numerical aperture is increased while the wavelength is kept constant, comatic aberration caused by tilt of the disc poses a problem and thus, a method in which thickness of a layer allowing transmission of the light beam is reduced is employed. An optical disc medium employing such method is proposed in Japanese Patent Laid-Open Publication No. 10-326435 (1998).

FIG. 12 shows a section of a conventional optical disc 300. The conventional optical disc 300 includes a light transmitting layer 301, a recording layer 302 for receiving a laser spot 304 via the light transmitting layer 301 and a substrate 303. Usually, the substrate 303 is formed by polycarbonate. The light transmitting layer 301 is formed by a thin sheet of polycarbonate and adhesive ultraviolet resin or pressure-sensitive adhesive, etc. so as to have a thickness of about 0.003 to 0.177 mm. When a track pitch of the conventional optical disc 300 of the above described arrangement is made smaller than hitherto available ones, it is possible to secure a density not less than five times that of a DVD by setting a wavelength of a recording and reproducing beam at about 400 to 450 nm and employing an objective lens having a numerical aperture of 0.85.

However, development of a high-definition and high-precision optical disc substrate is indispensable for reducing the track pitch. Among others, in a molding process, it is important how accurately tracks of the narrow pitch or minute pre-pits can be transferred. It is extremely difficult to uniformly mold a signal recording face from its inner periphery to its outer periphery by transferring such shapes. Usually, transfer at the inner periphery and the outer periphery of the signal recording face can be made substantially identically by raising temperature of dies of a molding machine. However, if the temperature of the dies of the molding machine is raised, warpage of the substrate itself becomes large and thus, the system is not operable.

### DISCLOSURE OF INVENTION

With a view to eliminating the above mentioned drawbacks of prior art, the present invention has for its object to provide a high-density optical disc medium in which substrate molding and signal quality are stable and which is suitable for reducing thickness of a device.

In order to accomplish this object of the present invention, an optical disc medium of the present invention includes a recording layer which has an inner peripheral region extending radially outwardly from a central bore to a signal start boundary and a signal region extending radially outwardly from the signal start boundary. A light transmitting layer is disposed on the recording layer and the signal region of one face of the recording layer adjacent to the light transmitting layer occupies a laser beam incident face such that either reproduction or recording and reproduction of information is performed from the recording layer via the light transmitting layer. The inner peripheral region of the face of the recording layer is formed flat and a recess is formed, on one face of the optical disc medium opposite to the light transmitting layer, in an area corresponding to the inner peripheral region of the recording layer.

### BRIEF DESCRIPTION OF DRAWINGS

FIG. 1 is a sectional view of a disc molding die for molding a substrate of an optical disc of the present invention.

FIG. 2 is a sectional view of an optical disc according to a first embodiment of the present invention.

FIG. 3 is a graph showing relation between radius and transfer ratio at the time of molding of a substrate of the optical disc of FIG. 2.

FIG. 4 is a table showing relation between sizes of a recess and transfer ratio in the optical disc of FIG. 2.

FIG. 5 is a graph showing relation between track pitch and transfer ratio in the optical disc of FIG. 2.

FIG. 6 is a sectional view of an optical disc according to a second embodiment of the present invention.

FIGS. 7A and 7B are sectional views showing an optical disc which is a first modification of the optical disc of FIG. 6.

FIG. 8 is a sectional view showing an optical disc which is a second modification of the optical disc of FIG. 6.

FIG. 9 is a sectional view of a motor drive in which the optical disc of FIG. 6 is mounted.

FIG. 10 is a sectional view of an optical disc according to a third embodiment of the present invention.

FIG. 11 is a sectional view showing an optical disc which is a modification of the optical disc of FIG. 10.

FIG. 12 is a sectional view of a prior art optical disc.

### BEST MODE FOR CARRYING OUT THE INVENTION

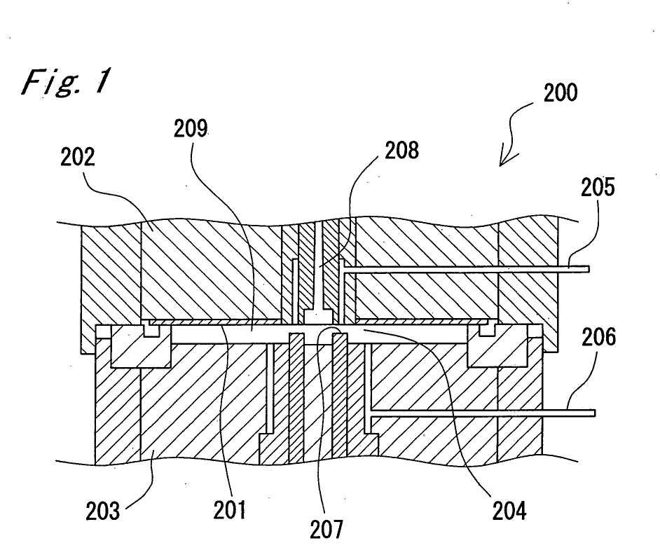

Hereinafter, embodiments of the present invention are described with reference to the drawings. FIG. 1 shows a disc molding die 200 for molding a substrate of an optical disc of the present invention. The substrate of the optical disc is manufactured by mounting this disc molding die 200 on a molding machine. By filling resin acting as material of the substrate from an inlet 208 into a cavity 209, i.e., a clearance defined between a stationary die 202 and a movable die 203, the substrate is formed. A stamper 201 having grooves or pits for forming a recording and reproducing region of signals is fixed by a stamper engagement portion 204 so as to transfer the grooves or the pits to the substrate. Meanwhile, the stationary die 202 and the movable die 203 have release gas inlet passages 205 and 206, respectively.

Then, molding operation is described. Initially, before the movable die 203 comes into contact with the stationary die 202, the resin molten at high temperature is introduced into the cavity 209 from the inlet 208. When the movable die 203 applies pressure to the stationary die 202 upon its contact with the stationary die 202, the disc is formed in the cavity 209. At this time, the introduced resin is set at a temperature of about 380° C., while the stationary die 202 and the movable die 203 are set at a temperature of about 120° C. The temperature of the dies 202 and 203 is set lower than that of the resin such that the resin is cooled and solidified in the dies 202 and 203. The substrate of the optical disc of the present invention is manufactured by using this disc molding die 200 and shape of a recess of the substrate is produced to various sizes by an annular projection 207.

### FIRST EMBODIMENT

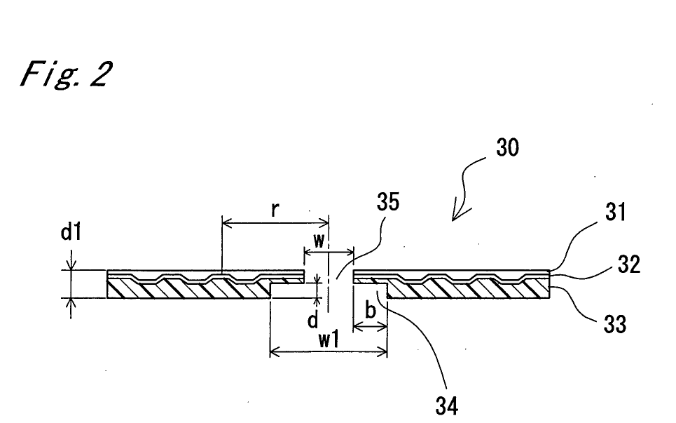

FIG. 2 shows a section of an optical disc 30 according to a first embodiment of the present invention. The optical disc 30 includes a substrate 33 molded by the disc molding die 200, a recording layer 32 and a light transmitting layer 31. The substrate 33 formed with a recess 34 by the disc molding die 200 is usually formed by polycarbonate. The light transmitting layer 31 is formed by a thin sheet of polycarbonate and adhesive ultraviolet resin or pressure-sensitive adhesive, etc.

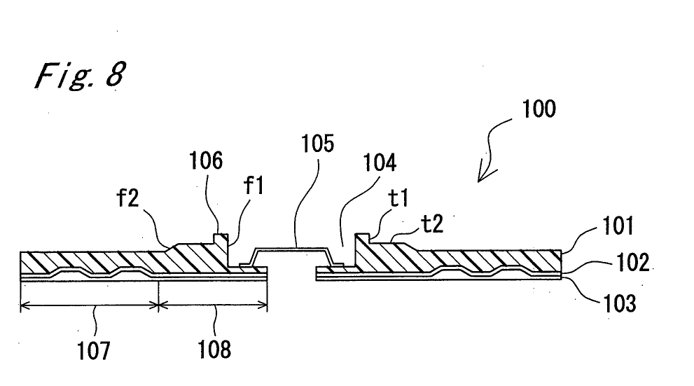

In FIG. 2, a signal region 107 (FIG. 8) disposed at an outer peripheral portion of an upper face of the recording layer 32 acts as a laser beam incident face, while a disc clamp region 108 (FIG. 8) disposed at an inner peripheral portion of the upper face of the recording layer 32 is formed flat. The outer peripheral signal region 107 and the inner peripheral disc clamp region 108 of FIG. 8 are separated from each other by a signal start boundary. Meanwhile, the recess 34 is provided in an area of the substrate 33, which corresponds to the disc clamp region 108 of the recording layer 32. Here, in order to set the light transmitting layer 31 at a thickness of 100 microns, the polycarbonate sheet is set at a thickness of 70 microns and the ultraviolet resin is set at a thickness of 30 microns. In this embodiment, the polycarbonate sheet is bonded to the recording layer 32 by spin coating the ultraviolet resin. Meanwhile, guide grooves for recording and reproduction are provided in the substrate 33 and have a depth of 140 nm. Furthermore, the optical disc 30 has a central bore 35.

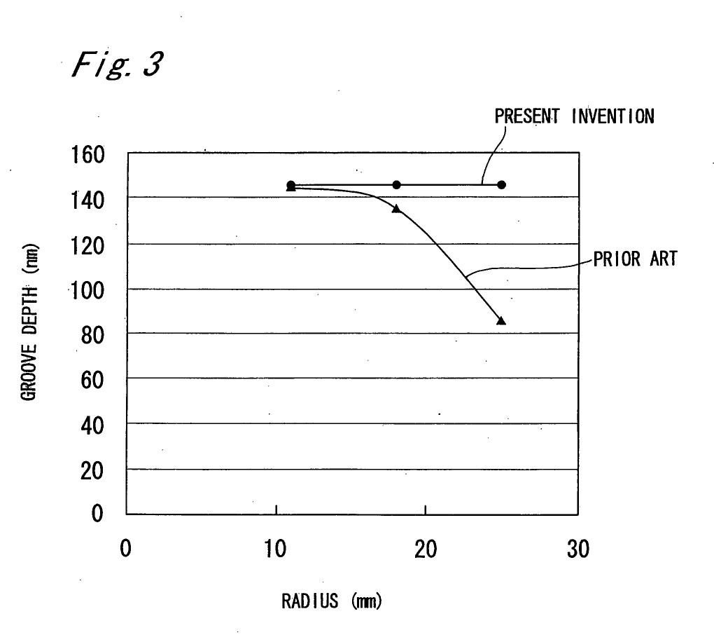

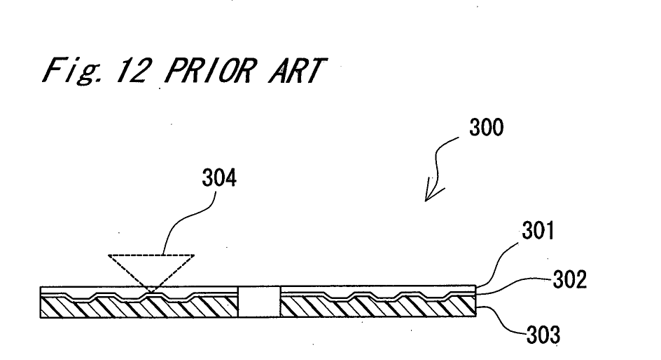

FIG. 3 shows relation between radius and transfer ratio at the time of molding of the substrate 33 of the optical disc 30. For comparison, values of a substrate 303 of an earlier mentioned conventional optical disc 300 of FIG. 12 are shown in FIG. 3. In FIG. 3, the abscissa axis represents radius of the substrate 33 in mm, while the ordinate axis represents transfer ratio of groove depth in nm. In the substrate of the conventional optical disc, transfer ratio deteriorates towards the outer periphery. On the other hand, under the condition of the same die temperature, an identical groove depth can be obtained from the inner periphery to the outer periphery of the substrate 33 of the optical disc 30 of the present invention.

This results from the recess 34 formed on the substrate 33 of the optical disc 30. At the time of molding of the substrate 33, the resin held at high temperature is introduced into the dies. However, since the die temperature is equal to a solidification point of the resin, cooling of the resin is started simultaneously with introduction of the resin into the dies. Here, if a convex and concave portions are not formed on a light incident face and its opposite face of a substrate in the same manner as the substrate 303 of the conventional optical disc 300, the resin proceeds to the outer periphery of the substrate while being cooled. As a result, the resin does not penetrate into high-density grooves, i.e., thin grooves formed on the stamper, thereby resulting in deterioration of transfer property.

On the other hand, in the substrate 33 of the optical disc 30 of the present invention, the resin introduced into the dies is once restricted at the recess 34. At this time, pressure of the resin rises upon its restriction at the recess 34 and thus, the resin is set in a reheated state. Therefore, since the resin which has passed through the recess 34 proceeds to the outer peripheral portion of the substrate 33 while being held at high temperature, the resin is completely transferred to even the high-density grooves. Meanwhile, since the substrate 33 can be molded while the dies are held at low temperature, there is no increase of tilt of the substrate 33 due to rise of the die temperature.

Supposing that the substrate 33 has a thickness of 1.1 mm and an outside diameter of 80 mm and the recess 34 has a size of 2 mm from an inside diameter of the substrate 33 and a depth of 0.3 mm, Table 1 below shows transfer ratio at a diameter of the central bore 35, i.e., an inside diameter w of the disc in mm and a radial position r of the disc in mm. By molding the substrate 33 by the use of a stamper having a track pitch of 0.3 microns, a groove width of 0.2 microns and a groove depth of 30 nm, the transfer ratio is calculated by dividing a groove depth of the molded substrate 33 by the groove depth of the stamper. At the time of molding, the resin has a temperature of 380° C. and the dies have a temperature of 125° C. The formed grooves have a diameter of 22 to 79 mm.

TABLE 1

| Inside diameter | Transfer ratio | Transfer ratio | Transfer ratio |
|---|---|---|---|
| w (mm) | (%) (r = 22) | (%) (r = 30) | (%) (r = 39) |
| 6 | 100 | 98 | 97 |
| 10 | 100 | 99 | 98 |
| 15 | 100 | 100 | 98 |
| 20 | 100 | 100 | 100 |

It is seen from Table 1 that even in a quite small disc having the inside diameter w of 6 mm, a remarkably excellent transfer ratio of 97% is obtained. In case the inside diameter w of the disc is small, it becomes difficult to perform transfer at the outer peripheral signal region due to cooling of the resin. However, in the present invention, when the inside diameter w of the disc is smaller than 20 mm, sufficient transfer ratios can be gained. In addition, even if the inside diameter w of the disc is not more than 6 mm, a usable disc can be manufactured.

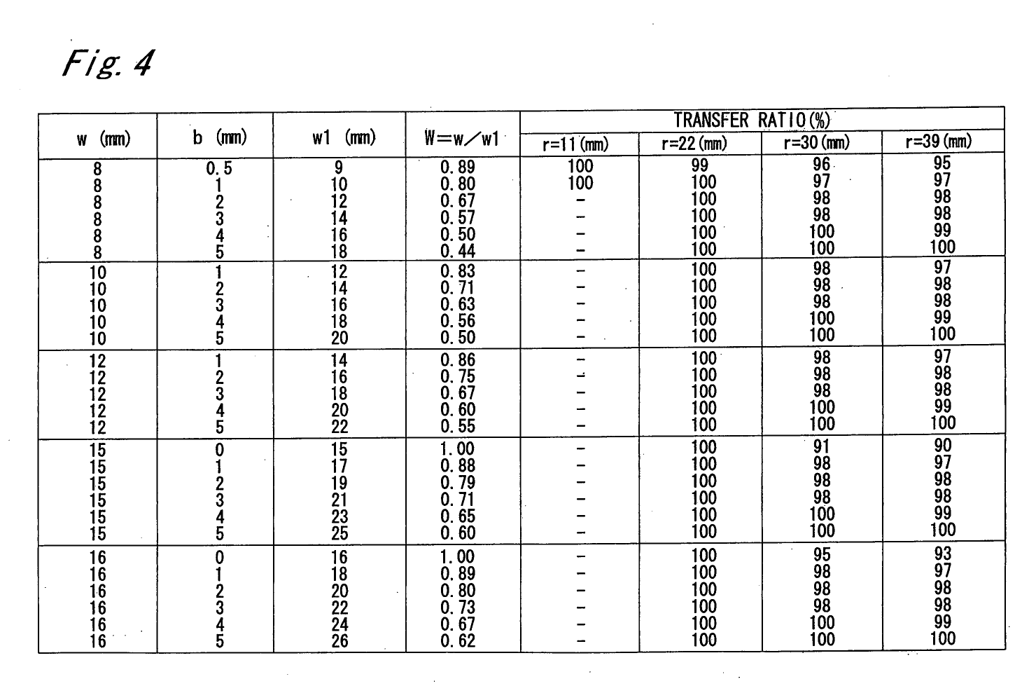

By setting a thickness and an outside diameter of the substrate 33 at 1.1 mm and 80 mm, respectively, FIG. 4 shows relation between various sizes of the recess 34 and transfer ratio. The depth of the recess 34 is 0.3 microns. By molding the substrate 33 by the use of the stamper having the track pitch of 0.3 microns, the groove width of 0.2 microns and the groove depth of 30 nm, the transfer ratio is calculated by dividing a groove depth of the molded substrate 33 by the groove depth of the stamper. When the disc has the inside diameter w in mm and the recess 34 has a diameter w1 in mm, “W” denotes a ratio of (w/w1). At this time, a width b of the recess 34 in mm is expressed by the following equation.
b=(w1−w)/2

In FIG. 4, at the ratio W of 0.89, the transfer ratio drops slightly irrespective of the inside diameter w but is about 95% which seems to have little influence on recording and reproduction. Meanwhile, in order to perform recording and reproduction at a satisfactory level, the transfer ratio preferably exceeds 90%. By using the substrate 33 of the optical disc 30 in this embodiment of the present invention, sufficient transfer ratios can be obtained at the ratio W of 0.44 to 0.89 when the inside diameter w ranges from 8 to 15 mm.

Meanwhile, in FIG. 4, cases of (W=1) at the inside diameter w of 15 or 16 mm correspond to conventional disc shapes but it is seen that effects of the present invention are hardly gained at the inside diameter w of 16 mm. This is probably because the large inside diameter w increases the inlet path of the resin, thereby resulting in rise of the transfer ratio. In this embodiment, since a difference with the case of (W=1) is found at the inside diameter w of 15 mm, the effects of the present invention are achieved in a disc having the inside diameter w of not more than 15 mm.

TABLE 2

| | Transfer ratio | Transfer ratio | Transfer ratio |
|---|---|---|---|
| d1-d (mm) | (%) (r = 22) | (%) (r = 30) | (%) (r = 39) |
| 0.1 | 98 | 98 | 96 |
| 0.2 | 100 | 100 | 98 |
| 0.4 | 100 | 100 | 98 |
| 0.6 | 100 | 100 | 99 |
| 0.8 | 100 | 100 | 99 |
| 1.1 | 100 | 94 | 90 |
| 1.2 | 100 | 89 | 80 |

By setting a thickness and an outside diameter of the substrate 33 at 1.2 mm and 80 mm, respectively, Table 2 above shows relation between various depths of the recess 34 and transfer ratio. The ratio W of the inside diameter w of the disc to the diameter w1 of the recess 34 is set at 0.7. By molding the substrate 33 by the use of the stamper having the track pitch of 0.3 microns, the groove width of 0.2 microns and the groove depth of 30 nm in the same manner as described above, the transfer ratio is calculated by dividing a groove depth of the molded substrate 33 by the groove depth of the stamper. As shown in FIG. 2, supposing that “d” denotes a depth of the area of the recess 34 and “d1” denotes an overall thickness of the disc body, namely, the members 31 to 33, a depth of the recess 34 is expressed by (d1−d). The depth of (d1−d) of the recess 34 represents a distance from a bottom face of the recess 34 to a surface of the light transmitting layer 31. Here, the depth of (d1−d) of the recess 34 is changed from 1.2 mm corresponding to a state of absence of the recess 34 to 0.1 mm.

It was found that the transfer ratio is improved drastically by merely changing the depth of (d1−d) of the recess 34 from 1.2 mm to 1.1 mm. On the contrary, when the depth of (d1−d) of the recess 34 is 0.1 mm, the remaining disc body has a thickness of mere 0.1 mm, filling of the resin becomes insufficient, thus resulting in drop of the transfer ratio. Moreover, in this case, since the inside diameter of the disc is deformed during handling of the substrate 33 at the time the substrate 33 is transferred from a molding process to a deposition process, the disc cannot be used actually.

However, if the depth (d1−d) of the recess 34 reaches 0.2 mm, both the transfer ratio and handling property are upgraded. Since rigidity of the disc body is approximately proportional to a cube of its thickness, it is considered that the disc is not deformed during its handling. Therefore, it was confirmed that the present invention applies to a range in which the depth of (d1−d) of the recess 34 is smaller than 0.12 mm but is larger than 0.1 mm. Furthermore, in view of rigidity of the recess 34, it is most desirable that the depth of (d1−d) of the recess 34 ranges from 0.3 to 0.8 mm.

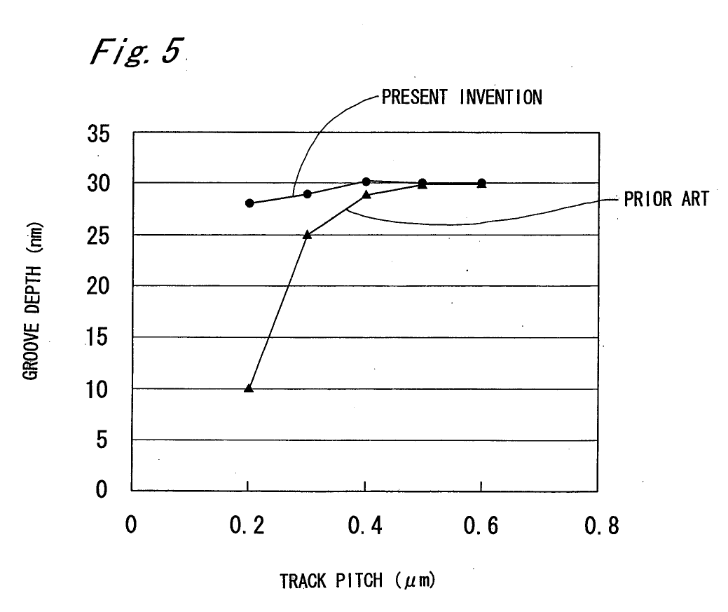

FIG. 5 shows relation between track pitch and transfer ratio in the substrate 33 of the optical disc 30. The optical disc 30 employed in the present invention has such relations as (W=0.8) and {(d1−d)=0.6 mm}. In the stamper used for molding, the grooves have a depth of 30 nm, a ratio between widths of concave portions (groove portions) and convex portions (land portions) of the grooves is 1:1 and the track pitch is changed from zone to zone. In FIG. 5, when the track pitch becomes smaller than 0.4 μm, transfer of the grooves deteriorates in a conventional optical disc. On the other hand, in the optical disc of the present invention, transfer can be performed sufficiently even when the track pitch is 0.2 μm.

Meanwhile, in this embodiment, the present inventors conducted experiments by setting the outside diameter of the substrate 33 at 80 mm. However, in the optical disc 30, the outside diameter of the substrate 33 is not restricted to 80 mm but similar effects are obtained also when the substrate 33 has an outside diameter of, for example, about 50 mm or 120 mm.

### SECOND EMBODIMENT

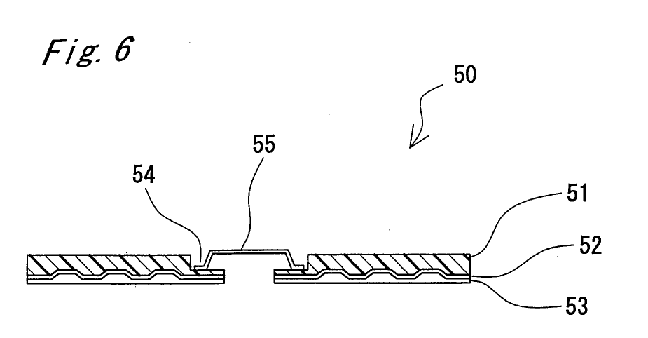

FIG. 6 shows a section of an optical disc 50 according to a second embodiment of the present invention. The optical disc 50 includes a substrate 51 molded by the disc molding die 200, a recording layer 52 and a light transmitting layer 53 and has a recess 54. The substrate 51 formed with the recess 54 by the disc molding die 200 is usually formed by polycarbonate. The light transmitting layer 53 is formed by a thin sheet of polycarbonate and adhesive ultraviolet resin or pressure-sensitive adhesive, etc. Here, in order to set the light transmitting layer 53 at a thickness of 100 microns, the polycarbonate sheet is set at a thickness of 70 microns and the ultraviolet resin is set at a thickness of 30 microns. Meanwhile, guide grooves used for recording and reproduction are provided in the substrate 51 and have a depth of 140 nm. Furthermore, a hub 55 made of magnetic material is mounted in the recess 54 of the substrate 51. The hub 55 is fixed to the recess 54 by using adhesive or by performing ultrasonic welding of a portion of the substrate 51.

Usually, when the optical disc 50 is secured to a turntable, available are a first method in which the disc is clamped mechanically by using a hub provided on an upper face of the disc, a second method in which a disc clamp claw is provided on the turntable and the disc is pressed against the disc clamp claw from below so as to be clamped and a third method in which a hub made of magnetic material is mounted on the disc and a magnet is provided on a motor so as to clamp the disc.

If the hub is provided on the upper face of the disc, height of the hub is added to that of the disc. Therefore, this design is disadvantageous for making a disc drive thinner. Hence, in the present invention, the hub 55 made of magnetic material is mounted in the recess 54 of the optical disc 50 as shown in FIG. 6. The magnetic hub 55 may be clamped by crushing an outer peripheral face of the recess 54 but can be produced simply by changing shape of the recess 54.

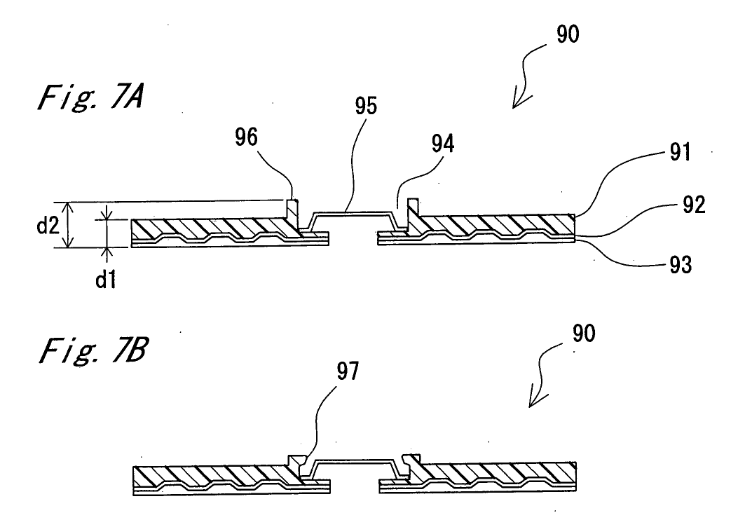

In order to positively mount the magnetic hub 55 on the substrate 51 in the optical disc 50 of FIG. 6, FIGS. 7A and 7 B show an optical disc 90 which is a first modification of the optical disc 50 of FIG. 6. In addition to a substrate 91, a recording layer 92, a light transmitting layer 93, a recess 94 and a magnetic hub 95, the optical disc 90 includes a protrusion 96 for welding the magnetic hub 95 to the substrate 91. The magnetic hub 95 of the optical disc 90 is equivalent to the magnetic hub 55 of FIG. 6. FIG. 7B shows a shape of a weld 97 obtained by crushing the protrusion 96 radially inwardly in the optical disc 90 by ultrasonic welding or heat. By providing the protrusion 96 along a periphery of the recess 94, the magnetic hub 95 can be easily mounted on the substrate 91. At this time, a height of the protrusion 96, which is necessary for ultrasonic welding, is set such that the magnetic hub 95 is not detached from the substrate 91 after the ultrasonic welding. The optical disc 90 of the present invention has the recess 94 and thus, a detachment dimension required for the optical disc 90 may be small. Supposing that “d2” denotes an overall height of the optical disc 90 including the protrusion 96 and “d1” denotes a thickness of the disc body, namely, an overall thickness of the members 91 to 93, about 1 mm on one side of the substrate 91 opposite to a light incident face will suffice for a height of (d2−d1) of the protrusion 96 but the height of (d2−d1) of the protrusion 96 preferably ranges from 1 to 5 mm according to the experiments of the present inventors.

Meanwhile, by forming on the substrate 91 the protrusion 96 having a width of not less than 0.1 mm, the weld 97 can be formed. The results of the experiments of the present inventors have revealed that the width of the protrusion 96 is not less than 0.2 mm preferably but ranges from 0.2 to 10 mm more preferably.

However, in case the protrusion 96 having, for example, a width of 0.1 mm and a height of 5 mm is injection molded, transfer of the resin to the protrusion 96 becomes unstable. Meanwhile, flow of the resin which has passed through the recess 94 is disturbed by the protrusion 96 and thus, an underside portion of the disc opposite to the protrusion 96, namely, -a disc clamp region may also become unstable.

Thus, in order to form the protrusion 96 stably, FIG. 8 shows an optical disc 100 which is a second modification of the optical disc 50 of FIG. 6. The optical disc 100 includes a substrate 101, a recording layer 102, a light transmitting layer 103, a recess 104, a magnetic hub 105 and a protrusion 106 and has a signal region 107 and a disc clamp region 108 which are, respectively, disposed at an outer peripheral portion and an inner peripheral portion of the recording layer 102. The signal region 107 and the disc clamp region 108 are separated from each other by a signal start boundary. In FIG. 8, the signal region 107 of a lower face of the recording layer 102 occupies a laser beam incident face, while the disc clamp region 108 of the lower face of the recording layer 102 is formed flat. Meanwhile, the recess 104 is provided in an area of the substrate 101, which corresponds to the disc clamp region 108 of the recording layer 102. In the optical disc 100, the protrusion 106 has two step portions t1 and t2 and thus, the resin flows in the optical disc 100 more smoothly than the optical disc 90 of FIG. 7. Therefore, a welding dimension can be formed without a sacrifice of the disc clamp region 108. An inner peripheral face f1 and an outer peripheral face f2 of the protrusion 106 may be perpendicular to the beam incident face but are preferably inclined relative to a plane perpendicular to the beam incident face in view of fluidity of the resin. In the protrusion 106 of FIG. 8, the inner peripheral face f1 is perpendicular to the beam incident face and only the outer peripheral face f2 is inclined relative to the plane perpendicular to the beam incident face.

Meanwhile, since in a radial direction of the optical disc 100, the outer peripheral face f2 of the protrusion 106 is disposed inwardly of a location corresponding to the signal start boundary of the recording layer 102, injection molding pressure rises again at the signal region 107. As a result, such two advantages are obtained that transfer is performed favorably and strength of the disc clamp region 108 is raised. According to the experiments of the present inventors, a width of the protrusion 106 including the inclined outer peripheral face f2 may be 1 mm or more but desirably ranges from 2 to 8 mm.

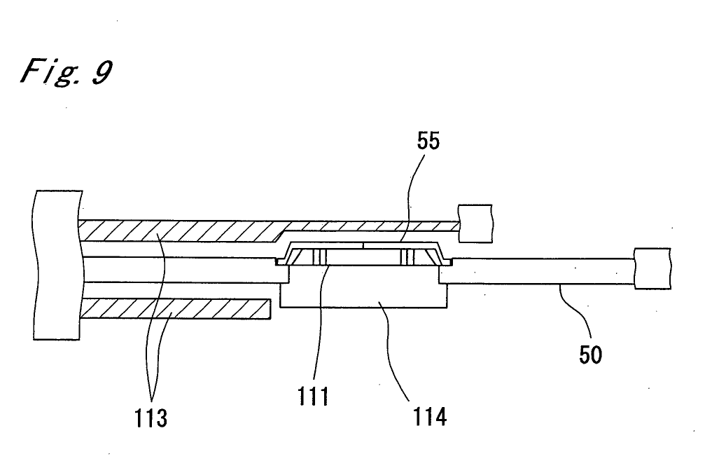

FIG. 9 shows a section of a motor drive in which the optical disc 50 of FIG. 6 is mounted. The optical disc 50 mounted with the magnetic hub 55 is fitted into a cartridge 113. The optical disc 50 is held by a magnet 111 provided in a motor 114. In case the optical disc 50 of the present invention is employed as shown in FIG. 9, use of the magnetic hub 55 not only enables the motor drive to be designed thinner than that of mechanical mounting of the disc but makes the cartridge 113 itself also thinner than that of an optical disc having no recess.

### THIRD EMBODIMENT

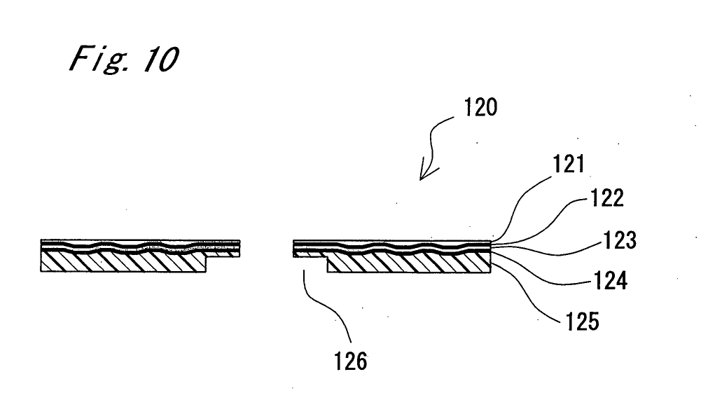

FIG. 10 shows a section of an optical disc 120 according to a third embodiment of the present invention. The optical disc 120 includes a light transmitting layer 121, a first recording layer 122, an intermediate layer 123 made of ultraviolet resin, a second recording layer 124 and a substrate 125 molded by the disc molding die 200 and has a recess 126. The substrate 125 provided with the recess 126 by the disc molding die 200 is usually formed by polycarbonate. The light transmitting layer 121 is formed by a thin sheet of polycarbonate and adhesive ultraviolet resin or pressure-sensitive adhesive, etc.

A method of manufacturing the intermediate layer 123 and the first recording layer 122 in the optical disc 120 of the present invention is described. Initially, after the substrate 125 has been molded, the second recording layer 124 for recording and reproducing signals is produced by sputtering. Then, the intermediate layer 123 is formed by spin coating the ultraviolet resin. A stamper for the first recording layer 122 is brought into close contact with the intermediate layer 123 so as to form grooves on the intermediate layer 123. After the stamper for the first recording layer 122 has been detached from the intermediate layer 123, the first recording layer 122 is produced by sputtering through adjustment of its thickness to such a value that the beam is transmitted through the first recording layer 122 up to the second recording layer 124. Furthermore, in the same manner as the first embodiment, the light transmitting layer 121 is formed by bonding the polycarbonate sheet to the first recording layer 122. Here, the intermediate layer 123 is set at a thickness of 25 microns, the polycarbonate sheet is set at a thickness of 50 microns and the ultraviolet resin is set at a thickness of 25 microns such that a thickness from the second recording layer 124 to the surface of the light transmitting layer 121 assumes 100 microns.

The optical disc 120 is recorded and reproduced by performing both focusing and tracking on each of the first and second recording layers 122 and 124. Hence, recording and reproduction on the second recording layer 124 are performed by a beam transmitted through the first recording layer 122 and a beam reflected by the first recording layer 122. A beam which is reflected by the second recording layer 124 after having been transmitted through the first recording layer 122 drops in quantity as compared with a case of a single recording layer and therefore, is required to have quite high precision. In this embodiment, since the recess 126 is provided on one face of the optical disc 120 opposite to the light transmitting layer 121, transfer ratio of the grooves can be raised and thus, the grooves can be produced more accurately than a conventional optical disc.

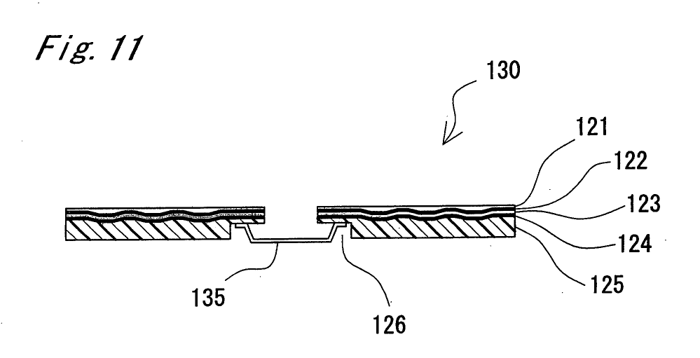

FIG. 11 shows an optical disc 130 which is a modification of the optical disc 120 of FIG. 10. In the optical disc 130, a metallic hub 135 corresponding to the magnetic hub 55 of FIG. 6 is mounted in the recess 126. Therefore, in the optical disc 130, the effects of the optical disc 50 of FIG. 6 can be achieved in addition to the effects of the optical disc 120 of FIG. 10.

In the embodiments of the present invention, the polycarbonate sheet is used for the light transmitting layer. However, the present invention is not limited to the polycarbonate sheet. For example, the polycarbonate sheet may also be replaced by an olefin resin sheet, an acrylic resin sheet, a sheet of ultraviolet resin only or a sheet of ultraviolet resin and polycarbonate.

Meanwhile, the light transmitting layer is set at a thickness of 0.1 mm but its thickness is not limited to 0.1 mm. For example, even if the light transmitting layer is set at a thickness of 0.3 mm by setting the polycarbonate sheet at a thickness of 0.25 mm and the ultraviolet resin at a thickness of 50 μm, similar effects are gained.

As is clear from the foregoing description, if the optical disc medium of the present invention is used, transfer property at the time of molding of the substrate can be upgraded greatly by maintaining disc tilt at a small value and the disc can be made thin, so that it is possible to provide an optical disc in which disc tilt is restrained to the small value and which is suitable for large capacity, high density and thin design.

1. An optical disc medium comprising:
a recording layer which has an inner peripheral region extending radially outwardly from a central bore to a signal start boundary and a signal region extending radially outwardly from the signal start boundary; and
a light transmitting layer which is disposed on the recording layer;
wherein the signal region of one face of the recording layer adjacent to the light transmitting layer occupies a laser beam incident face such that either reproduction or recording and reproduction of information is performed from the recording layer via the light transmitting layer;
wherein the inner peripheral region of the face of the recording layer is formed flat and a recess is formed, on one face of the optical disc medium opposite to the light transmitting layer, in an area corresponding to the inner peripheral region of the recording layer.

2. The optical disc medium as claimed in claim 1, wherein a diameter of the area of the recess is not less than 11 mm.

3. The optical disc medium as claimed in claim 1, wherein when the central bore has a diameter w and the recess has a diameter w1, a ratio W of (w/w1) ranges from 0.4 to 0.9.

4. The optical disc medium as claimed in claim 1, wherein when the area of the recess has a depth d in mm and a disc body of the optical disc medium has a thickness d1 in mm, a relation of (0.1<d1−d<1.2) is satisfied.

5. The optical disc medium as claimed in claim 1, wherein a track pitch is not more than 0.4 microns.

6. An optical disc medium comprising:
a recording layer which has an inner peripheral region extending radially outwardly from a central bore to a signal start boundary and a signal region extending radially outwardly from the signal start boundary;
a light transmitting layer which is disposed on the recording layer;
wherein the signal region of one face of the recording layer adjacent to the light transmitting layer occupies a laser beam incident face such that either reproduction or recording and reproduction of information is performed from the recording layer via the light transmitting layer;
wherein the inner peripheral region of the face of the recording layer is formed flat and a recess is formed, on one face of the optical disc medium opposite to the light transmitting layer, in an area corresponding to the inner peripheral region of the recording layer; and
a magnetic plate which is mounted in the recess.

7. The optical disc medium as claimed in claim 6, wherein a diameter of the area of the recess is not less than 11 mm.

8. The optical disc medium as claimed in claim 6, wherein when the central bore has a diameter w and the recess has a diameter w1, a ratio W of (w/w1) ranges from 0.4 to 0.9.

9. The optical disc medium as claimed in claim 6, wherein when the area of the recess has a depth d in mm and a disc body of the optical disc medium has a thickness d1 in mm, a relation of (0.1<d1−d<1.2) is satisfied.

10. The optical disc medium as claimed in claim 6, wherein a track pitch is not more than 0.4 microns.

11. An optical disc medium comprising:
a recording layer which has an inner peripheral region extending radially outwardly from a central bore to a signal start boundary and a signal region extending radially outwardly from the signal start boundary and is formed by at least two layers; and
a light transmitting layer which is disposed on the recording layer;
wherein the signal region of one face of the recording layer adjacent to the light transmitting layer occupies a laser beam incident face such that either reproduction or recording and reproduction of information is performed from the recording layer via the light transmitting layer;
wherein the inner peripheral region of the face of the recording layer is formed flat and a recess is formed, on one face of the optical disc medium opposite to the light transmitting layer, in an area corresponding to the inner peripheral region of the recording layer.

12. The optical disc medium as claimed in claim 11, wherein a diameter of the central bore is not more than 15 mm.

13. The optical disc medium as claimed in claim 11, wherein when the central bore has a diameter w and the recess has a diameter w1, a ratio W of (w/w1) ranges from 0.4 to 0.9.

14. The optical disc medium as claimed in claim 11, wherein when the area of the recess has a depth d in mm and a disc body of the optical disc medium has a thickness d1 in mm, a relation of (0.1<d1−d<1.2) is satisfied.

15. The optical disc medium as claimed in claim 11, wherein a track pitch is not more than 0.4 microns.

16. An optical disc medium comprising:
a recording layer which has an inner peripheral region extending radially outwardly from a central bore to a signal start boundary and a signal region extending radially outwardly from the signal start boundary and is formed by at least two layers;
a light transmitting layer which is disposed on the recording layer;
wherein the signal region of one face of the recording layer adjacent to the light transmitting layer occupies a laser beam incident face such that either reproduction or recording and reproduction of information is performed from the recording layer via the light transmitting layer;
wherein the inner peripheral region of the face of the recording layer is formed flat and a recess is formed, on one face of the optical disc medium opposite to the light transmitting layer, in an area corresponding to the inner peripheral region of the recording layer; and
a metal plate which is mounted in the recess.

17. The optical disc medium as claimed in claim 16, wherein a diameter of the area of the recess is not less than 11 mm.

18. The optical disc medium as claimed in claim 16, wherein when the central bore has a diameter w and the recess has a diameter w1, a ratio W of (w/w1) ranges from 0.4 to 0.9.

19. The optical disc medium as claimed in claim 16, wherein when the area of the recess has a depth d in mm and a disc body of the optical disc medium has a thickness d1 in mm, a relation of (0.1<d1−d<1.2) is satisfied.

20. The optical disc medium as claimed in claim 16, wherein a track pitch is not more than 0.4 microns.

21. The optical disc medium as claimed in claim 6, wherein a protrusion having a desired height relative to a thickness of a disc body of the optical disc medium is provided on the face of the optical disc medium.

22. The optical disc medium as claimed in claim 16, wherein a protrusion having a desired height relative to a thickness of a disc body of the optical disc medium is provided on the face of the optical disc medium.

23. The optical disc medium as claimed in claim 21, wherein when an overall height of the optical disc medium including the protrusion is expressed by d2 in mm and the thickness of the disc body is expressed by d1 in mm, a relation of (d2−d1<5) is satisfied.

24. The optical disc medium as claimed in claim 22, wherein when an overall height of the optical disc medium including the protrusion is expressed by d2 in mm and the thickness of the disc body is expressed by d1 in mm, a relation of (d2−d1<5) is satisfied.

25. The optical disc medium as claimed in claim 23, wherein a width of the protrusion is larger than 0.1 mm.

26. The optical disc medium as claimed in claim 24, wherein a width of the protrusion is larger than 0.1 mm.

27. The optical disc medium as claimed in claim 21, wherein the protrusion has two step portions.

28. The optical disc medium as claimed in claim 22, wherein the protrusion has two step portions.

29. The optical disc medium as claimed in claim 27, wherein in a radial direction of the optical disc medium, an outer peripheral face of the protrusion is disposed inwardly of a location corresponding to the signal start boundary of the recording layer.

30. The optical disc medium as claimed in claim 28, wherein in a radial direction of the optical disc medium, an outer peripheral face of the protrusion is disposed inwardly of a location corresponding to the signal start boundary of the recording layer.

31. The optical disc medium as claimed in claim 29, wherein at least one of the outer peripheral face and an inner peripheral face of the protrusion is inclined relative to a plane perpendicular to the laser beam incident face.

32. The optical disc medium as claimed in claim 30, wherein at least one of the outer peripheral face and an inner peripheral face of the protrusion is inclined relative to a plane perpendicular to the laser beam incident face.

33. The optical disc medium as claimed in claim 21, wherein an inner peripheral face of the protrusion is deformed.

34. The optical disc medium as claimed in claim 22, wherein an inner peripheral face of the protrusion is deformed.

35. The optical disc medium as claimed in claim 31, wherein the protrusion is deformed through melting by ultrasonic wave or heat.

36. The optical disc medium as claimed in claim 32, wherein the protrusion is deformed through melting by ultrasonic wave or heat.
